(19) United States
(12) Patent Application Publication
(10) Pub. No.: US 2014/0131064 A1
(43) Pub. Date: May 15, 2014

(54) FLAT CABLE AND METHOD FOR PREPARING THE SAME

(71) Applicant: Yazaki Corporation, Tokyo (JP)

(72) Inventor: Maki Yamada, Susono-shi (JP)

(73) Assignee: YAZAKI CORPORATION, Tokyo (JP)

(21) Appl. No.: 14/161,900

(22) Filed: Jan. 23, 2014

Related U.S. Application Data
(63) Continuation-in-part of application No. PCT/JP2012/004646, filed on Jul. 23, 2012.

(30) Foreign Application Priority Data
Jul. 27, 2011 (JP) 2011-164735

(51) Int. Cl. H01B 7/08; H01B 13/14

(52) U.S. Cl. CPC H01B 7/0823; H01B 13/14
USPC 174/117 F; 427/117

(57) ABSTRACT

The objective of the invention is to provide a thin and flexible flat cable suited for being arranged in a narrow space such as a vehicle, as well as, a method for stably preparing such a flat cable.

To attain the objective, there is provided a flat cable which has a plurality of conductors which is arranged parallel to each other, and an insulating layer disposed over the plurality of conductors by extrusion molding. The insulating layer has Melt flow rate value of 2.0 g/10 minutes or above at a molding temperature during the extrusion molding, and is formed of thermoplastic resin selected from the group consisting of polyolefin, polyphenylene ether, polyphenylene sulfide and a combination thereof.

### TECHNICAL FIELD

The present invention relates to a flat cable, in particular, a flat cable which is prepared by extrusion molding.

### BACKGROUND ART

A flat cable is used for, for example, electrical connection between a movable portion and a stationary portion due to its flexibility. In this case, the flat cable is highly flexible due to its intrinsic shape, only needs relatively small space, and is optionally suited for take-up. As a result, a flat cable can be used in a variety of applications including connection between movable portion such as a scanner head and printer head and a stationary portion such as a body portion, and a clock spring for a vehicle.

Such a flat cable can be often prepared by a lamination process. For reference, JP H10-278206(A) has proposed such a lamination process. In accordance with the proposed process, a conductor is coated or covered with a composite sheet where a heat sealing layer formed of heat sealable resin is stacked on a base resin formed of flame retardant, saturated polyester resin.

Due to the heat sealing layer high level of sliding flexible properties, which is generally needed as a flat cable, can be obtained, and thereby ensuring sufficient attachment to the conductor.

In accordance with the afore-mentioned process, there is however needed multiple steps, including providing a substrate or base sheet, forming a heat-sealing layer, and staking the heat-sealing layer on the substrate or base sheet (i.e., forming heat-sealing layer laminated substrate or base sheet). For the reasons as set forth above, the manufacture cost of the flat cable will be extremely greater than that of conventional insulated electrical wire which is manufactured via general extrusion molding. Even if the flat cable thus obtained has been used as a component or part needed to meet extremely high flexibility characteristics (for example, ten million times or above), it has only limited application to a slidable door size of which can be largely reduced by adopting the flat cable.

In view of the above, WO 98/52199 has proposed a process for manufacture of a flat cable. In accordance with the proposed process, thermoplastic resin having elastic modulus of from 800 to 2400 Mpa is employed, and the flat cable is prepared via extrusion molding. The flat cable thus obtained is alleged to have enhanced flexibility.

However, in a case where the thermoplastic resin having elastic modulus of from 800 to 2400 Mpa is used, the conductor is hardly coated with the thermoplastic resin, or is not uniformly coated with the thermoplastic resin during the formation of a thin fiat cable.

In this regard, there has not been proposed or taught any approach where an insulating layer disposed over the conductor can be formed in a thickness of 0.2 mm or below, which allows for use in a narrow space such as a vehicle.

### CITATION LIST

### Patent Literature

[PTL 1] JP H10-278206 (A)

[PTL 2] WO 98/52199

### SUMMARY OF INVENTION

### Technical Problem

In order to overcome the above-referred drawbacks and problems, there is provided a novel method for stably manufacturing a thin flat cable which has an insulating layer having a thickness of 0.2 mm or below which is disposed over a conductor, and a novel thin flat cable having enhanced flexibility in comparison with the conventional flat cable. The flat cable can be desirably arranged in a narrow space such as a vehicle.

### Solution to Problem

In one aspect, the present invention provides a flat cable, which has a plurality of conductors that is arranged parallel to each other, and an insulating layer disposed over the plurality of conductors by extrusion molding. The insulating layer has Melt flow rate of 2.0 g/10 minutes or above at a molding temperature during the extrusion molding, and is formed of thermoplastic resin selected from the group consisting of polyolefin, polyphenylene ether, polyphenylene sulfide, and a combination thereof.

Preferably, the conductor has a thickness of from 0.02 mm to 0.5 mm, and the insulating layer has a thickness of from 0.02 mm to 0.5 mm in a portion in which the conductor is disposed. The thickness of the conductor may be a diameter if a circular conductor is employed.

Preferably, the flat cable is used as a flat cable for connection between a movable portion and a stationary portion in a vehicle.

In other aspect, the invention provides a novel method for preparing any of the afore-mentioned flat cables, which includes the step of molding the insulating layer by extrusion molding.

### Advantageous Effects of Invention

The flat cable in accordance with the invention is that and flexible enough to be arranged in a narrow space such as a vehicle.

The method for preparing a flat cable in accordance with the invention allows for stable production of thin and flexible flat cable at low cost.

### BRIEF DESCRIPTION OF DRAWINGS

FIG. 1 shows a cross section of an embodiment of a flat cable in accordance with the invention.

FIG. 2 shows a cross section of a flat cable which is manufactured in accordance with an example as described below. FIG. 2A represents a cross section of one embodiment of a conductor portion.

FIG. 2 shows a cross section of a flat cable which is manufactured in accordance with an example as described below. FIG. 2B represents a cross section of one embodiment of a flexible flat cable in accordance with the invention.

### Description of Embodiments

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

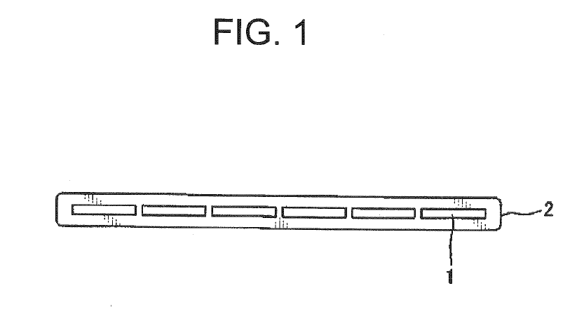

FIG. 1 is a cross-sectional view of a flat cable A in accordance with one embodiment of the invention.

Referring to FIG. 1, a flat cable is comprised of six conductors 1, which each have rectangular cross sections and are arranged parallel to each other, and an insulating layer 2 disposed over the six conductors. In other words, the conductors 1 are surrounded by the insulating layer 2. In this regard, the conductor 1 having rectangular cross section is also called hereinafter as “rectangular conductor”. However, the invention is not limited to the rectangular conductor as shown in FIG. 1, and also encompasses other known conductors such as a conductor having an annular cross section.

The rectangular conductor 1 which can be employed in one embodiment of the invention can be formed of copper, copper alloy, aluminum, aluminum alloy, and etc.

The thickness of the rectangular conductor may be from 0.02 mm to 0.5 mm which can provide enough capacity, intensity (i.e., strength), and flexibility for a flat cable. The width of the rectangular conductor can be determined to ensure enough capacity associated with an intended application. In this case, it is not necessary that all of the conductors are identical to each other in their widths. In other words, the width of each rectangular conductor may be independently determined. Moreover, the number of the conductors which constitute a flat cable may be properly determined in dependence on its intended application.

The thickness of the resin layer of the flat cable as used herein can be defined as a thickness of the thinnest portion of the resin layer which is disposed over the conductor 1. The thickness of the resin layer of the flat cable is preferably 0.02 mm or above so as to ensure sufficient intensity (i.e., strength), as well as enough insulating properties. Furthermore, the thickness of the resin layer of the flat cable is preferably 0.5 mm or below so as to ensure sufficient flexibility. The width of the flat cable can be properly determined in dependence on the number of the conductors used and specific application.

The resin layer has Melt flow rate (value) of 2.0 g/10 minutes or above at a temperature for molding during extrusion molding, and is formed of thermoplastic resin selected from the group consisting of polyolefin, polyphenylene ether, and polyphenylene sulfide.

The term “Melt flow rate” value (i.e., MFR value) as used herein can be determined in accordance with JIS K7210B.

In the invention, a temperature for extrusion molding (i.e., a molding temperature during extrusion molding) as used herein can be a temperature of a nozzle portion of an extruder.

In the invention, if Melt flow rate value is less than 2.0g/10 minutes, molding properties is poor, and a thinner flat cable which has enhanced flexibility cannot be stably produced. In accordance with one embodiment of the invention, the insulating layer is formed of thermoplastic resin selected from the group consisting of polyolefin, polyphenylene ether, and polyphenylene sulfide.

The polyolefin resin as mentioned previously includes, but is not limited to, polypropylene, and olefin-based thermoplastic elastomer.

The polypropylene can withstand organic solvent and hydrolysis environments, and has enough heat resistance of about 100 Celsius degrees needed for normal use. The polypropylene resin includes, but is not limited to, propylene homopolymer, propylene ethylene random copolymer, propylene-alpha-olefin random copolymer, or a combination thereof.

The olefin-based thermoplastic elastomer can be comprised of polyethylene, propylene, and etc. as a hard segment component, and ethylene propylene diene monomer rubber (EPDM rubber), ethylene propylene rubber (i.e., EPM rubber), and etc. as a soft segment component. The olefin-based thermoplastic elastomer can be used in alone or a combination.

Among these Prime Polymer R110E can be preferably used in terms of high levels of flowability and flexibility.

Moreover, polyphenylene ether can be generally used in admixture with polypropylene. In this situation, remarkably enhanced heat resistance of 125 Celsius degrees or above can be obtained, thereby allowing for use in an engine room.

Furthermore, due to its better thermal resistance polyphenylene sulfide can be used in more severe location, for example, just below an engine room.

One embodiment of the flat cable in accordance with the invention may be formed of resin composition which further includes flame retardants, flame retardant aids, or additives without adversely affecting the desired effect sought by the invention.

The above descriptions are made mainly with reference to the flexible flat cable. However, the invention is not limited to the flexible flat cable, and may also include other types of flat cable such as a ribbon cable.

The flat cable in accordance with the invention will be further illustrated hereinafter.

The following examples are offered for illustrative purposes only, and are not intended to limit the scope of the present invention in any way. Indeed, various modifications of the invention in addition to those shown and described herein will become apparent to those skilled in the art from the foregoing description and the following examples and fall within the scope of the appended claims.

A variety of resin compositions, Examples # 1-5, and Comparative Examples # 1-3 were prepared by mixing or blending the materials or components as listed in Table 1 in their amount as indicated in Table 2, and subsequently kneading the mixture or blend by using a twin screw extruder. In this situation, the amount (i.e., content) is represented by parts by weight, unless the context clearly dictates otherwise.

TABLE 1
Abbreviation

| PP-1 | polypropylene | Prime Polymer Co., Ltd., E150GK |
|---|---|---|
| PP-2 | polypropylene | SunAllomer Ltd., PM970A |
| PP-3 | olefin-based thermoplastic | Prime Polymer Co., Ltd., R110E |
| | elastomer | |
| m-PP | Maleic acid modified | Sanyo Chemical Industries, Ltd., |
| | thermoplastic elastomer | Youmex 1001 |
| LDPE | low density polyethyelene | Japan Polyethylene Corporation, |
| | | Novatec LD400 |
| PPE-1 | polyphenylene ether + | Asahi Kasei CHEMICALS |
| | polypropylene | CORPORATION, ZYRON T0701 |
| PPE-2 | polyphenylene ether + | Misui Chemicals, Inc. Noryl |
| | polypropylene | WCV072 |
| SEBS | hydrogenated styrene-based | Asahi Kasei CHEMICALS |
| | thermoplastic elastomer | CORPORATION, Tuftec P2000 |
| PPS-1 | polyphenylene sulfide | Chevron Corporation, XE5300NA |
| PPS-2 | polyphenylene sulfide | Polyplastics Co., Ltd., 0220A9 |
| B | bromine-based flame retardant | Allbemarle Corporation, |
| | | SAYTEX8010 |
| SEB | flame retardant aid (antimony | NSK Ltd., PATOX-M |
| | trioxide) | |
| M | inorganic flame retardant | Koywa Chemical Industry Co., Ltd. |
| | (magnesium hydroxide) | KISUMA 5A |
| P | phosphorous flame retardant | ADEKA CORPORATION, FP- |
| | | 600 |

TABLE 2

| | | | | | poly- | | | |
|---|---|---|---|---|---|---|---|---|
| | | | | | phenylene | | polyphenylene | |
| | Polypropylene resin | | | | ether resin | | sulfide resin | |
| | | Ex. | Ex. | Ex. | Com. | Ex. | Com. | Ex. |
| Abbreviation | Com. Ex. #1 | #1 | #2 | #3 | Ex. #2 | # 4 | Ex. #3 | #5 |
| PP-1 | 60 | 30 | 10 | 20 | | | | |
| PP-2 | | 20 | 45 | 35 | | 55 | | |
| PP-3 | | 10 | 20 | 20 | | | | |
| m-PP | 30 | 20 | 10 | 10 | | 5 | | |
| LDPE | 10 | 20 | 15 | 15 | | | | |
| PPE-1 | | | | | | 40 | | |
| PPE-2 | | | | | 100 | | | |
| PPS-1 | | | | | | | 100 | |
| PPS-2 | | | | | | | | 100 |
| SEBS | | | | | | 15 | | |
| B | 40 | 40 | 40 | 40 | | | | |
| SEB | 10 | 10 | 10 | 10 | | | | |
| M | 30 | 30 | 30 | | | | | |
| P | | | | 30 | 20 | 20 | | |

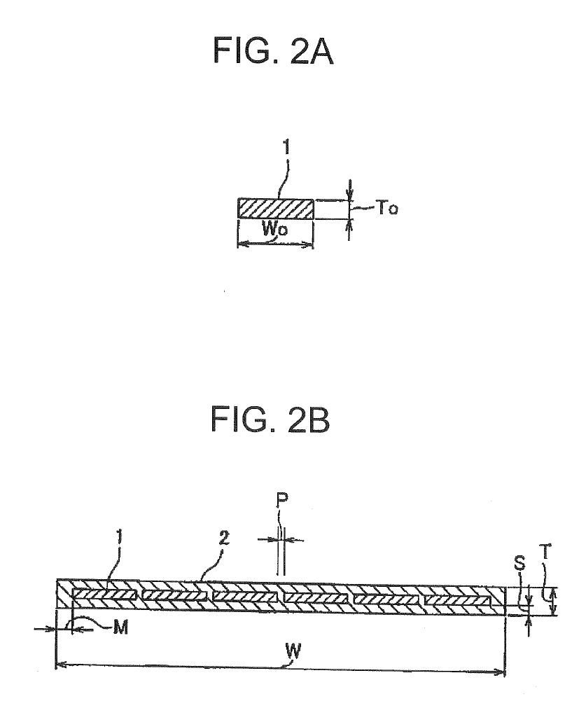

Flat cables were respectively formed of these eight resin compositions, and prepared by using extrusion molding. As shown in FIG. 2, six rectangular conductors were arranged in parallel to each other in the across-the-width direction such that a distance (P) between two rectangular conductors was 0.5 mm. A set of rectangular conductors (i.e., six rectangular conductors) were selected to have a width (Wo) of 2.0 mm and a thickness (To) of 0.15 mm, a width (Wo) of 2.0 mm and a thickness (To) of 0.10 mm, or a width (Wo) of 2.0 mm and a thickness (To) of 0.05 mm. Each of the resin composition was located around the six conductors, and was subjected to extrusion molding with a load of 2.16 kg. In this situation, the resin compositions for insulating layers were subjected to molding condition which was varied depending on the resin used. For more detail, polypropylene was subjected to a temperature of 235 Celsius degrees in Comparative Example 1 and Examples 1-3; polyphenylene ether was subjected to a temperature of 250 Celsius degrees in Comparative Example 2 and Example 4; and polyphenylene sulfide was subjected to a temperature of 300 Celsius degrees in Comparative Example 3 and Example 5. During extrusion molding twenty six flat cables were molded such that their insulating layers each had a width (W) of 15.5 mm, and a thickness (S) of 0.20 mm, 0.15 mm, 0.10 mm, or 0.08 mm. In this regard, the thickness (S) means the thickness of the insulating layer which is located around the conductor. The several flat cables thus obtained were subjected to the following tests and evaluations. The results are summarized in Tables 3 and 4 as listed below.

In these tables, MFR values which were determined in accordance with JIS K7210B are recorded in g/10 minutes. For reference, MRF values were determined at molding temperature during extrusion molding.

TABLE 3

| resin | | | | | | | | | | | | | | |
|---|---|---|---|---|---|---|---|---|---|---|---|---|---|---|
| composition | Com. Ex. #1 | | | | | | Ex. #1 | | | Ex. #2 | | | Ex. #3 | |
| MFR value (g/10 | 1.0 | | | | | | 5.9 | | | 2.5 | | | 2.2 | |
| minutes) | | | | | | | | | | | | | | |
| conductor thickness | 0.15 | 0.10 | 0.05 | 0.15 | 0.10 | 0.05 | 0.15 | 0.10 | 0.05 | 0.15 | 0.10 | 0.05 | 0.15 | 0.10 |
| (mm) | | | | | | | | | | | | | | |
| insulating layer | 0.20 | 0.20 | 0.20 | 0.10 | 0.10 | 0.10 | 0.20 | 0.20 | 0.20 | 0.08 | 0.08 | 0.08 | 0.15 | 0.15 |
| thickness S (mm) | | | | | | | | | | | | | | |
| appearance evaluation | passed | passed | passed | failed | failed | failed | passed | passed | passed | passed | passed | passed | passed | passed |
| structural evaluation | failed | failed | failed | failed | failed | failed | passed | passed | passed | passed | passed | passed | passed | passed |

TABLE 4

| resin | | | | | | | | | | | | |
|---|---|---|---|---|---|---|---|---|---|---|---|---|
| composition | Com. Ex. #2 | | | Com. Ex. #4 | | | Com. Ex. #3 | | | Ex. #5 | | |
| MFR value | 0.5 | | | 3.5 | | | 0.8 | | | 4.5 | | |
| (g/10 minutes) | | | | | | | | | | | | |
| conductor | 0.15 | 0.15 | 0.05 | 0.15 | 0.15 | 0.05 | 0.15 | 0.15 | 0.15 | 0.15 | 0.15 | 0.15 |
| thickness(mm) | | | | | | | | | | | | |
| insulating | 0.15 | 0.10 | 0.15 | 0.15 | 0.10 | 0.15 | 0.15 | 0.15 | 0.15 | 0.15 | 0.15 | 0.15 |
| layer | | | | | | | | | | | | |
| thickness | | | | | | | | | | | | |
| S(mm) | | | | | | | | | | | | |
| appearance | failed | failed | failed | passed | passed | passed | failed | failed | failed | passed | passed | passed |
| evaluation | | | | | | | | | | | | |
| structural | failed | failed | Failed | passed | passed | passed | failed | failed | failed | passed | passed | passed |
| evaluation | | | | | | | | | | | | |

Each of the twenty six flat cables as mentioned previously was evaluated in terms of its appearance and structure.

### Appearance Test and Evaluation

The resultant flat cables were subjected to visual observation. If there was not observed any of deformation, distortion, floating or peeling of the resin layer tested, the associated flat cable was evaluated to pass the appearance test. To the contrary, if there was observed any of deformation, distortion, floating or peeling of the resin layer tested, the associated flat cable was evaluated to fail the appearance test.

### Structural Test and Evaluation

The each resulting flat cable at every 50 m was embedded in epoxy resin so as to prevent the flat cable from folding. Subsequently, the flat cable was cut together with the epoxy resin. The cut surface was ground, and a surface which was not affected by cutting deformation was observed under a microscope. At the same time, the thickness of the insulating layer which was located over the conductor was determined. If all of the thickness measurements fell within the range of the predetermined value as mentioned previously (i.e., 0.02 mm, 0.15 mm, 0.10 mm, or 0.08 mm) with a margin of error of plus or minus 0.05 mm, it was considered to obtain a flat cable with stable structure, which means that the associated flat cable passed the structural test. To the contrary, if the thickness thus determined did not fall within the range of the predetermined value with a margin of error of plus or minus 0.05 mm, it was considered to fail to obtain a flat cable with a stable structure.

The afore-mentioned test results and evaluations are listed in Tables 3 and 4 above.

The results as listed in Tables above show that the embodiment of the flat cable in accordance with the invention meets appearance and structural requirements.

While a preferred embodiment of the invention has been shown and described with particularity, it will be appreciated that various changes and modifications may suggest themselves to one having ordinary skill in the art upon being apprised of the present invention. It is also intended to encompass all such changes and modifications as fall within the scope and spirit of the appended claims.

### REFERENCE SIGNS LIST

1 rectangular conductor

2 insulating layer (i.e., an insulating covering)

1. A flat cable, comprising:
a plurality of conductors which is arranged parallel to each other, and an insulating layer disposed over the plurality of conductors by extrusion molding, wherein the insulating layer has Melt flow rate value of 2.0 g/10 minutes or above at a molding temperature during the extrusion molding, and is formed of thermoplastic resin selected from the group consisting of polyolefin, polyphenylene ether, polyphenylene sulfide and a combination thereof.

2. The flat cable according to claim 1, wherein the conductor has a thickness of from 0.02 mm to 0.5 mm, and wherein the insulating layer has a thickness of from 0.02 mm to 0.5 mm in a portion in which the conductor is disposed.

3. The flat cable according to claim 1, wherein the flat cable is used as a flat cable for connection between a movable portion and a stationary portion in a vehicle.

4. A method for preparing a flat cable according to claim 1, comprising the step of molding the insulating layer by extrusion molding.
